(19) United States
(12) Patent Application Publication
(10) Pub. No.: US 2009/0139876 A1
(43) Pub. Date: Jun. 4, 2009

(54) Apparatus and Method for Measuring Hydrogen Concentration

(75) Inventors: Matthew Paul Hills, Cambridgeshire (GB); Mark Anthony Steele Henson, Staffordshire (GB)

Correspondence Address: SALIWANCHIK LLOYD & SALIWANCHIK;A PROFESSIONAL ASSOCIATION, PO Box 142950, GAINESVILLE, FL, 32614, US

(73) Assignee: Enviromental Monitoring and Control Limited, Stafford (GB)

(21) Appl. No.: 12/089,870

(22) PCT Filed: Oct. 11, 2006
(86) PCT No.: PCT/GB2006/003775

§ 371 Date: Sep. 10, 2008

(30) Foreign Application Priority Data
Oct. 12, 2005 (GB) 0520777.4

(51) Int. Cl. G01N 27/26

(52) U.S. Cl. 205/775; 204/421

(57) ABSTRACT

The subject invention pertains to an apparatus for measuring hydrogen concentration, wherein the apparatus comprises a sensor comprising a sensor wall enclosing a cavity containing a metal/hydrogen reference. A portion of the wall is formed of a proton-conducting solid electrolyte, connected to a reference electrode on its surface within the cavity and a measurement electrode on its surface outside the cavity. The apparatus comprises a hygroscopic material in the region of the sensor, to enable rehydration of the sensor following hydrogen concentration measurements.

The invention relates to an apparatus and a method for measuring hydrogen concentration, and in particular for measuring dissolved hydrogen concentration in molten metals.

It is important to monitor the concentration of hydrogen dissolved in molten metals, and in particular in molten aluminium and its alloys. The solubility of hydrogen in molten aluminium is much higher than its solubility in solid aluminium, and therefore when aluminium is cast there is a tendency for dissolved hydrogen in the melt to form bubbles or other flaws in the solid aluminium product. The hydrogen concentration in molten aluminium can rise through reaction of the aluminium with moisture in the environment, and so it is critical to be able to monitor hydrogen concentration during aluminium casting.

Hydrogen concentration in molten metals such as aluminium can be monitored by means of a proton-conducting solid-electrolyte sensor with an internal solid-state hydrogen reference. This technology has been described in published prior art, including ‘The Detection of Hydrogen in Molten Aluminium’ by D P Lapham et al, Ionics 8 (2002), pages 391 to 401, ‘Determination of Hydrogen in Molten Aluminium and its Alloys using an Electrochemical Sensor’ by C Schwandt et al, EPD Congress 2003, TMS (The Minerals, Metals and Materials Society), 2003, pages 427 to 438, and in International patent application No. PCT/GB2003/003967 of Cambridge University Technical Services Limited. All of these documents are incorporated herein by reference in their entirety. An advantageous method for taking measurements from such a probe, termed the ‘reverse current technique’ has been described in European patent application No. EP 98932375.3 of D J Fray and R V Kumar, which is also incorporated herein by reference in its entirety.

In sensors and probes of this type, as described in the prior art it is known that it is important to maintain an adequate partial pressure of water within the sensor cavity, in which the solid-state hydrogen reference is contained. If this is not done, then under measurement conditions in molten aluminium, for example, the solid electrolyte can dehydrate due to the extremely low water partial pressure in equilibrium with molten aluminium. H⁺ (proton) conductivity in the electrolyte depends on the partial pressure of water, and therefore as the sensor dehydrates, the H⁺ conductivity gradually decreases. Eventually, after prolonged exposure to the melt, the H⁺ conductivity can become so low that it is comparable to the O²⁻ conductivity in the electrolyte. In this case, the sensor emf (electro-motive force) becomes influenced by the oxygen partial pressure, leading to erroneous readings. The inventors term this effect “depletion”, or “dehydration”.

The invention provides an apparatus and a method for measuring hydrogen concentration, and a method for operating an apparatus for measuring hydrogen concentration, as defined in the appended independent claims, to which reference should now be made. Preferred or advantageous features of the invention are set out in dependent subclaims.

In a first aspect, the invention may thus provide an apparatus for measuring hydrogen concentration, in which a sensor comprises a sensor wall enclosing a cavity containing a metal/hydrogen reference, for generating a reference partial pressure of hydrogen within the cavity. At least a first portion of the sensor wall is of a proton-conducting solid electrolyte. The electrolyte is provided with a reference electrode on its surface within the cavity and a measurement electrode on its surface outside the cavity, for exposure to a hydrogen concentration to be measured. A voltage, or EMF, measured between the reference electrode and the measurement electrode can then provide a measurement of the hydrogen concentration outside the sensor. The apparatus is characterised in that it comprises a hygroscopic material in the region of the sensor.

The presence of the hygroscopic material may advantageously provide a material which can be replenished with water and thus rehydrate the sensor, as may be required because of sensor dehydration as tends to occur when the sensor is exposed to molten metal, such as molten aluminium, as described above.

The hygroscopic material may form part of the sensor itself, such as a second portion of the sensor wall, or may be used in a component of the apparatus near to the sensor, or preferably adjacent to the sensor. For example, the apparatus may comprise a probe body defining a chamber for receiving the sensor. In this case, the probe body may advantageously comprise the hygroscopic material.

In a further example, the probe body may comprise a protective sheath surrounding the sensor, in which case the protective sheath may advantageously comprise the hygroscopic material.

The probe body and/or the sensor may conveniently be couplable to a probe support for immersion in molten metal. The sensor may then advantageously be removable from the probe support and/or the probe body for servicing, including for rehydration; in one such embodiment the sensor may be removable from the probe body; in another the probe body may house the sensor and be removably coupleable from the probe support together with the sensor. Alternatively, re-hydration may be carried out with the probe body and/or the sensor coupled to the probe support.

The hygroscopic material may comprise aluminium nitride (AIN) and/or boron nitride (BN).

In a further aspect, the invention may advantageously provide a method for operating an apparatus for measuring hydrogen concentration as described above. The method may then include the step of exposing the apparatus, or a part of the apparatus comprising the sensor, to a rehydrating environment. If exposure, or repeated exposure, of the apparatus to molten metal leads to dehydration of the sensor, then performing this re-hydration step from time to time may advantageously offset the effect of the dehydration and extend the lifetime of the sensor and/or improve its accuracy.

The rehydrating environment may be ambient air, or humidified air, or may be a moist gas or mixture of gases. The exposure to the rehydrating environment may be carried out at ambient temperature or at elevated temperature. Depending on the complexity of the rehydrating step, it may be appropriate to expose the entire apparatus, which may for example be a probe for measuring hydrogen concentration, or a part of the apparatus, which may comprise a probe body and the sensor, or just the sensor, to the rehydrating environment. For example, if the rehydrating environment is ambient air at ambient temperature, then there may be no need to disassemble the apparatus. If, however, a specially-prepared rehydrating environment is required, which may for example be prepared in an enclosure of limited volume, then it may be appropriate to expose only a part of the apparatus to the rehydrating environment; this may or may not require disassembly of the apparatus.

In a particularly-preferred embodiment, the rehydrating environment is ambient air and the rehydrating step occurs automatically on withdrawal of the apparatus and the sensor from the molten metal. Thus, if a dehydrated or partially-dehydrated probe is withdrawn from an aluminium melt, then as the apparatus and the sensor cool, they are exposed to ambient air. In the particularly-preferred embodiment, this exposure is sufficient to rehydrate the hygroscopic material, and therefore the sensor.

As described above, the problem addressed by the invention is the dehydration of the solid electrolyte, which may not itself be hygroscopic. Thus, the re-hydration may be achieved by rehydrating a hygroscopic material in the vicinity of the solid electrolyte and the sensor cavity and allowing diffusion from the hygroscopic material to the solid electrolyte and the cavity to achieve the re-hydration.

In a further aspect of the invention, dehydration of the solid electrolyte may be monitored during use of the hydrogen-sensing apparatus through measurement of the impedance, or resistance, of the sensor. The resistance of the solid electrolyte between the reference electrode and the measurement electrode depends on the hydration of the solid electrolyte. In an embodiment of this aspect of the invention, after manufacture of a sensor, two calibration values R₇₀₀ and R₇₅₀ (which are the resistance of the sensor at 700 C and 750 C respectively), are measured and programmed into an electronic analyser. The resistance of the sensor at any temperature in its as-manufactured, hydrated state can then be calculated using the two calibration values and the Arrhenius dependence of conductivity on temperature. During use, the analyser monitors the sensor's actual resistance and its deviation from the calculated value at the same temperature and can, for example, flag any deviation greater than a predetermined threshold, such a 5 kOhms deviation.

This strategy may advantageously provide an accurate indication of the condition of the electrolyte and allow the analyser to display an indication of dehydration of the sensor. For example, the analyser may simply display the measured deviation from the sensor's as-manufactured resistance, or it may display an appropriate error message if the deviation exceeds a predetermined threshold. A user may then respond to the analyser display by performing an appropriate re-hydration step to rehydrate the sensor.

It should be noted that the temperatures 700 C and 750 C for measurement of the calibration resistance values, and the use of only two calibration values, are arbitrary; other calibration temperatures and/or more than two temperatures may be used.

Using these various aspects of the invention in combination; it can be seen that an operational strategy for rehydrating the hydrogen-sensing apparatus as required to maintain sensor accuracy may advantageously be implemented.

### SPECIFIC EMBODIMENTS AND BEST MODE OF THE INVENTION

Specific embodiments of the invention will now be described by way of example, with reference to the accompanying drawings in which:

FIG. 1 is a longitudinal section of a first hydrogen sensor;

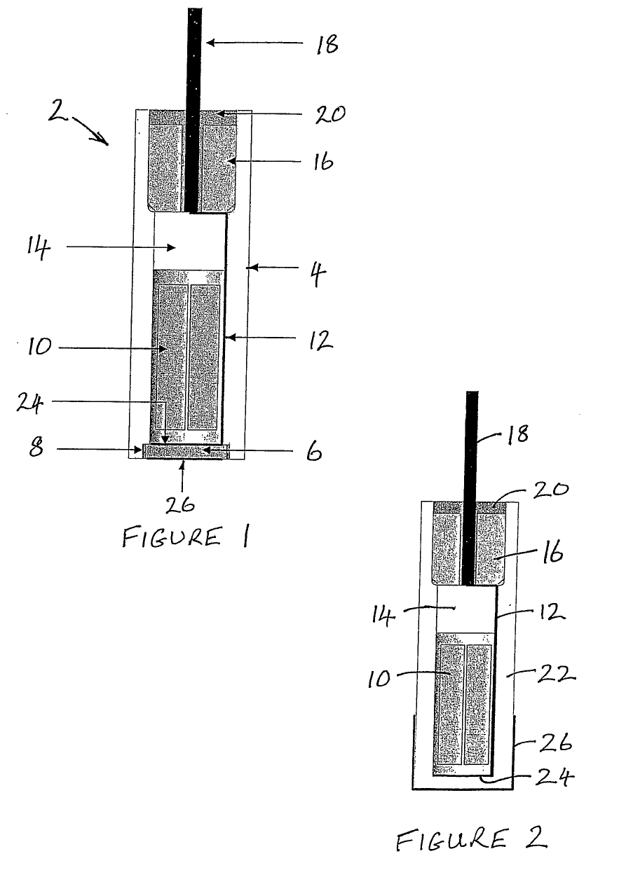

FIG. 2 is a longitudinal section of a second hydrogen sensor;

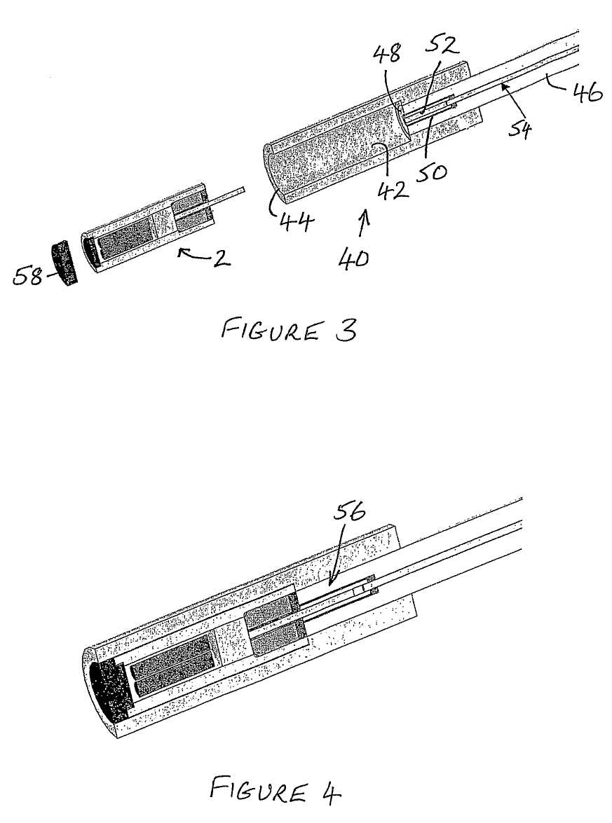

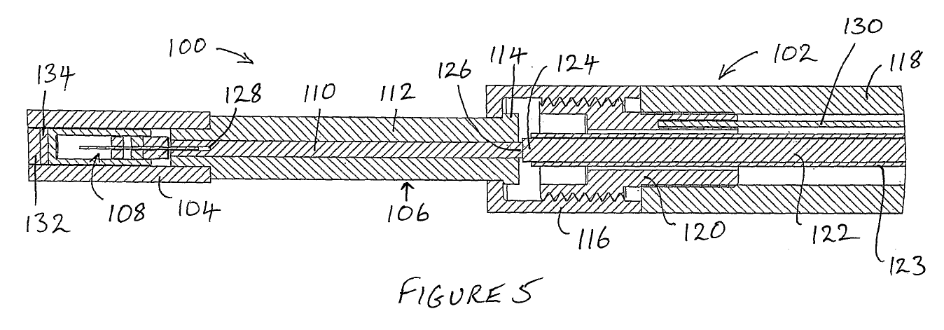

FIG. 3 is an exploded sectional view of a probe embodying the invention, incorporating the sensor of FIG. 1;

FIG. 4 is an assembled sectional view of the probe of FIG. 3;

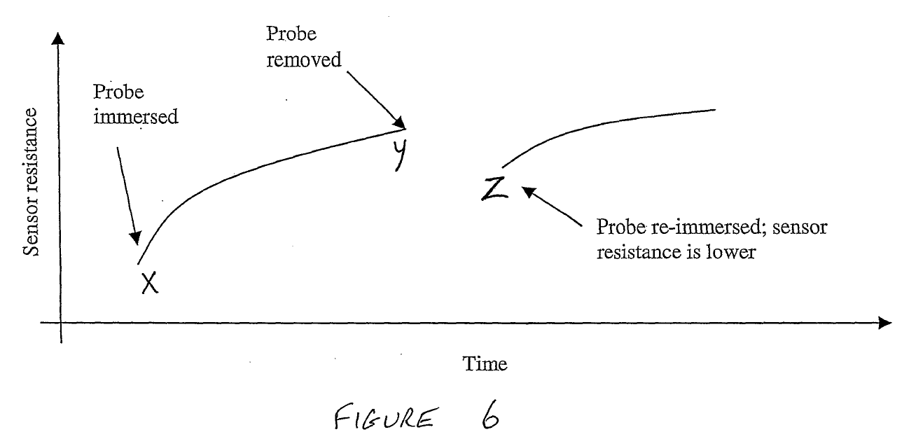

FIG. 5 is a longitudinal section of a hydrogen probe according to a further embodiment of the invention;

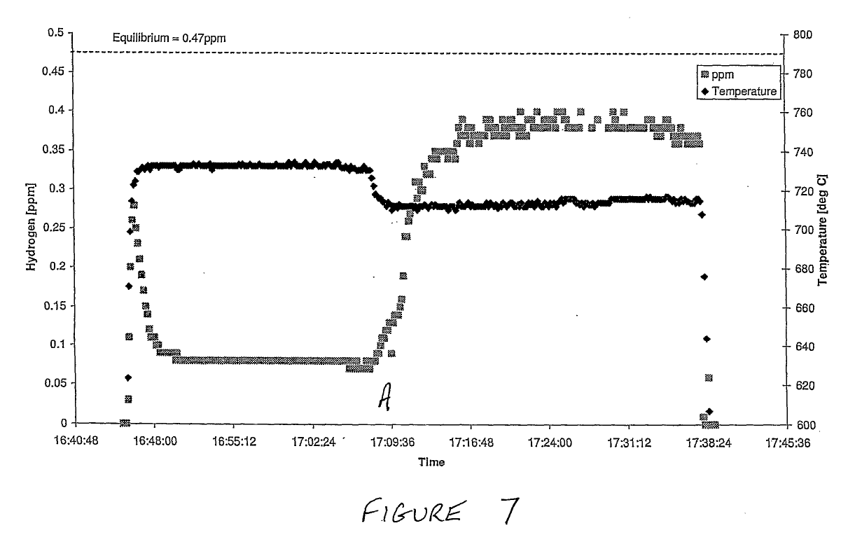

FIG. 6 is a plot of sensor resistance against time for a probe embodying the invention being immersed in molten aluminium and rehydrated in ambient air;

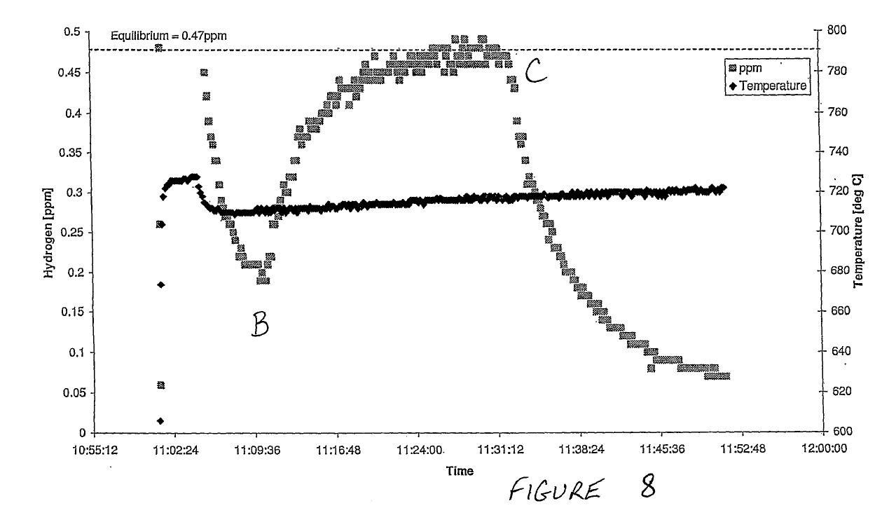

FIG. 7 is a plot of measured hydrogen concentration against time for a dehydrated sensor embodying the invention; and

FIG. 8 is a plot of measured hydrogen concentration against time during rehydration of the sensor of FIG. 6.

Embodiments of the invention will be described with reference to hydrogen sensors as illustrated in FIG. 1 to 4. The structures of the sensors of the embodiments are described below.

FIG. 1 is a longitudinal section of a hydrogen sensor 2. The sensor has a sensor body comprising a tube 4, closed at one end by a planar solid-electrolyte disc 6. The disc has a porous platinum electrode 24, 26 formed on each surface and is sealed into a recess in the end of the tube using a silica-free glass 8. A metal-metal hydride reference material 10 is inserted into the tube behind the reference electrode and an electrical conductor 12 extends from the reference electrode along an internal wall of the tube. A volume within the tube above the reference material is filled with an inert buffer material 14 such as Y₂O₃ powder. A sensor cap 16 is then inserted into an upper end of the tube. An electrode wire 18 extending through a hole in the sensor cap makes contact with the electrical conductor 12. The electrode wire is sealed in the hole and the sensor cap is sealed to the tube using a glass seal 20, preferably of a silica-free glass. The solid electrolyte disc, the tube and the sensor cap form the walls of a sensor body enclosing a sealed cavity. The cavity contains the solid reference material, which generates a reference hydrogen partial pressure within the cavity. The electrode wire extends outwardly from the sensor body, coaxial with the tube.

The solid electrolyte is preferably of indium-doped calcium zirconate. The tube and the sensor cap are preferably manufactured from undoped calcium zirconate, in which case the thermal expansion of the tube is matched to that of the electrolyte disc and the sensor cap, allowing the sensor to be thermally cycled without the build up of excessive thermal stresses. Alternatively, the tube and sensor cap can be manufactured from magnesia-magnesium aluminate (MMA), which has a thermal expansion coefficient slightly higher than the indium-doped calcium zirconate electrolyte. In this case, the electrolyte is permanently in a state of compressive stress under measurement conditions (immersed in molten metal), increasing the thermal shock and thermal cycling resistance of the electrolyte.

The diameter of the electrolyte disc in the embodiment is 3 mm and the outer diameter of the tube is 4 mm.

FIG. 2 illustrates an alternative sensor which differs from the sensor of FIG. 1 in that the tube and the solid electrolyte disc are fabricated as a single component, termed a thimble 22. Thus, in this case, the wall of the sensor body consists of a closed-ended indium-doped calcium zirconate tube, which is closed at its open end by a sensor cap and an electrode wire in the same way as the sensor of FIG. 1. Components common to FIGS. 1 and 2 are given the same reference numerals in both Figures.

FIGS. 3 and 4 illustrate the assembly of a probe comprising a probe body 40 and a sensor 2, as shown in FIG. 1. FIG. 3 is an exploded view of the probe and FIG. 4 is an assembled view of the probe.

The probe body encloses a probe body chamber 42 which terminates at an opening 44. The probe body is of generally cylindrical shape and at the end of the chamber opposite the opening, a central bore in the probe body receives an end of a probe support 46. An end 48 of the probe support forms a portion of an end surface of the chamber and is brazed or sealed to the probe body. A blind bore 50 lined with a metallic tube 52 extends coaxially from the chamber within the probe support. The blind bore terminates at an electronic conductor 54 which runs along central bore within the probe support. The end of the electronic conductor is sealed at the end of the blind bore using brazing or a glass seal to ensure that the end of the chamber is hermetically sealed.

The chamber 42 is shaped so as to receive the sensor 2 and, when the sensor is fully inserted in the chamber, the electrode wire 18 enters and makes electrical contact with the metal tube 52, which thus forms a reference-electrode connection 56, as shown in FIG. 4. After the sensor has been inserted into the chamber, a hydrogen-permeable seal or barrier 58 is inserted, as an interference fit, into the opening 44, closing the chamber and mechanically retaining the sensor within the chamber.

Advantageously, there is sufficient clearance between the sensor and the probe body to allow free expansion and contraction of the sensor during the thermal cycling caused by immersion of the probe into molten metal, without the sensor body being constrained by the probe body as the probe is heated and cooled.

With the sensor is in place within the chamber and the hydrogen-permeable seal in place, the hermetic sealing of the chamber at its sides and at its end opposite the hydrogen-permeable seal prevents any leakage of hydrogen out of the measuring chamber when measurements are made and protects the sensor from environmental contamination.

The hydrogen-permeable seal prevents direct contact between the molten aluminium and the solid electrolyte or other components of the sensor. It is important that direct contact between molten aluminium and the electrolyte should be avoided as this causes the electrolyte to leave the hydrogen-ion-conduction domain and to enter the oxygen-ion-conduction domain. In that case, the potential of the measurement electrode would be determined by the oxygen activity at that electrode rather than the activity of hydrogen, leading to erroneous readings. The hydrogen-permeable seal is, however, electrically conductive and serves to make an electrical connection between the measuring electrode and the molten metal. An analyser can therefore make electrical contact with the measurement electrode through the melt, and with the reference electrode through the electronic conductor within the probe support. Graphite felt, graphite wool or a grade of graphite with open porosity are suitable materials for the hydrogen-permeable barrier in this embodiment.

The probe support should be made from an electrically-insulating material to prevent a short circuit between the reference and measurement electrodes when the probe is immersed in the melt. Alumina is a suitable material for the probe support as long as its diameter is sufficiently small (3 mm or less) to avoid damage due to thermal cycling. Other suitable materials are SiAION or silicon nitride. Importantly, any thermal expansion mismatch between the probe support and the probe body should be taken into account to ensure that the two are held tightly together when the probe is heated to its operating temperature.

In the embodiment of FIGS. 3 and 4 the sensor is removably received in the chamber of the probe body and the probe body is secured to the probe support. In an alternative embodiment, the probe body is removably couplable to the probe support, for example by means of a screw thread or a threaded collar. In this alternative embodiment the sensor may or may not also be removably received in a chamber of the probe body.

FIG. 5 illustrates an embodiment in which a probe body 100 is removably couplable to a probe support 102 (only the end of the probe support is shown in the drawing). The probe body 100 comprises a probe-body sleeve 104 bonded, or push-fitted, to an end of a probe-body shaft 106. The end of the shaft and the interior of the sleeve define a probe-body chamber within which a sensor 108 is received. The sensor and the structure of the chamber are similar to those illustrated in FIGS. 3 and 4.

The probe-body shaft 106 comprises a central core 110 of SiC extending axially within an electrically-insulating SiAION sheath 112. A flange 114 extends radially outwards from the end of the sheath distant from the probe-body sleeve, and engages an end wall of an internally-threaded graphite collar 116.

The probe-body shaft 102 comprises a SiAION tube 118 and a boss 120 bonded within an end of the tube. An externally-threaded portion of the boss extends from the end of the tube, onto which the graphite collar can be threaded. A reference-electrode conductor 122, covered by an insulating coating 123 except at its end 124, extends axially within the probe support; when the graphite collar is threaded onto the end of the probe support, the end 124 of the reference-electrode conductor contacts an end 126 of the SiC core within the probe-body shaft. The other end of the SiC core is formed with an axial blind bore 128 for receiving and making electrical contact with the reference-electrode conductor of the sensor 108.

A measurement-electrode conductor 130 extends within the probe support and, during use of the probe, makes contact with the measurement electrode by means of the boss 120 (which is made of electrically-conductive SiC), the graphite collar 116, the melt in which the probe is immersed, a hydrogen-permeable graphite seal 132 inserted into the end of the probe-body sleeve 104, and a disc 134 of graphite-wool packing between the seal 132 and the sensor 108.

The reference-electrode conductor 122 within the probe support is urged by a spring (not shown) out of the end of the probe support. Thus, as the graphite collar is threaded onto the boss, the probe-body flange 114 is urged against the end wall of the graphite collar and the probe body securely positioned at the end of the probe support.

In this embodiment, the probe may be disassembled both by removing the probe body from the probe support and by removing the sensor from the probe-body chamber, if required for servicing and/or rehydration.

### Dehydration and Rehydration

The probe body in FIGS. 3 and 4, and the probe-body sleeve of FIG. 5, are fabricated from a hygroscopic material so that it can be rehydrated, and so that the absorbed water can diffuse towards the sensor to rehydrate the solid electrolyte. The probe body material should also meet other requirements, such as being a material of high density, in order to avoid gaseous diffusion (of hydrogen) through the chamber walls, of high thermal shock resistance, in order to allow rapid immersion into the melt without breakage, of low thermal expansion coefficient, and which is chemically stable in contact with the molten metal during measurement. Machinable-grade aluminium nitride, which may contain a proportion of boron nitride, is a suitable material and additionally allows the body to be manufactured cheaply by machining, preferably with no grinding being required. Magnesia may also be used.

The inventors have observed, as illustrated in FIG. 6, that when a sensor as described above is immersed in molten aluminium (at point X in FIG. 6), the sensor resistance rises with time due to dehydration (to point Y), as expected. When the probe is removed from the melt, allowed to cool in ambient air, and then re-immersed, the sensor resistance is advantageously reduced (point Z). The reduction in sensor resistance is due to the absorption of water by the hygroscopic material in the region of the sensor, namely the aluminium nitride and boron nitride of the probe body.

The inventors have also demonstrated experimentally that the performance of a depleted, or dehydrated, sensor in a probe as illustrated in FIG. 5, for example, can be recovered by exposing the probe body and sensor to a moist gas mixture of hydrogen diluted in argon carrier gas. FIG. 7 illustrates the performance of such a sensor which is suffering from depletion, having been immersed in molten aluminium for over ten hours. At a predetermined time (marked A in FIG. 7) a gas mixture of 30% hydrogen was injected into the melt using a rotary gas injection unit. After the melt has reached equilibrium with the gas, the analyser reading should level off at 0.47 ppm (parts per million). However, as shown in FIG. 7 the sensor measurement levels off at about 0.40 ppm. The difference between 0.40 ppm and 0.47 ppm is due to sensor depletion.

The probe and sensor were subsequently removed from the melt and held at 800 C for three hours in a gas mixture of 1% H₂ in argon, which had been bubbled through water at room temperature, thus providing a water vapour pressure of about 2%.

FIG. 8 shows the performance of this replenished sensor in the melt. At time B, when the sensor reading had initially stabilised, a gas mixture of 30% hydrogen was injected into the melt using the rotary gas injection unit. The sensor output rose to indicate 0.47 ppm, the correct equilibrium hydrogen concentration. At time C, the melt was then degassed by injection of nitrogen through the rotary gas injection unit, reducing the hydrogen concentration in the melt as indicated by the falling of the sensor output.

Again, it can therefore be seen that rehydration of the hygroscopic material of the probe body adjacent the sensor may advantageously rehydrate the solid electrolyte and improve its performance.

We claim:

1: An apparatus for measuring hydrogen concentration, in which a sensor comprises a sensor wall enclosing a cavity containing a metal/hydrogen reference, a first portion of the wall being of a proton-conducting solid electrolyte;
characterised in that the apparatus comprises a hygroscopic material in the region of the sensor.

2: The apparatus according to claim 1, in which a component of the apparatus adjacent to the sensor comprises the hygroscopic material.

3: The apparatus according to claim 1, in which a component of the sensor comprises the hygroscopic material.

4: The apparatus according to claim 1, in which a second portion of the wall of the sensor comprises the hygroscopic material.

5: The apparatus according to claim 1, comprising a probe body for receiving the sensor, or integral with the sensor, and in which at least a portion of the probe body comprises the hygroscopic material.

6: The apparatus according to claim 1, in which the hygroscopic material comprises aluminium nitride.

7: The apparatus according to claim 1, in which the hygroscopic material comprises boron nitride.

8: A method for operating an apparatus for measuring hydrogen concentration, in which a sensor comprises a sensor wall enclosing a cavity containing a metal/hydrogen reference, a first portion of the wall being of a proton-conducting solid electrolyte, and the apparatus comprising a hygroscopic material in the region of the sensor,
the method including the step of exposing the apparatus, or a part of the apparatus, to a rehydrating environment so as to offset dehydration that occurs during hydrogen-concentration measurement.

9: The method according to claim 8, in which the rehydrating environment is ambient air.

10: The method according to claim 8, in which the rehydrating environment is humidified air.

11: The method according to claim 8, in which the rehydrating environment is a moist gas or mixture of gases, such as a mixture of hydrogen in an inert gas.

12: The method according to any of claim 8, in which the apparatus or part of the apparatus is exposed to the rehydrating environment at ambient temperature.

13: The method according to any of claim 8, in which the apparatus or part of the apparatus is exposed to the rehydrating environment at an elevated temperature.

14: The method according to any of claim 8, in which the impedance of the solid electrolyte is measured and the rehydration step is implemented in response to a predetermined deviation of the sensor impedance from an expected or reference impedance value.

15: The method according to any of claim 8, in which the rehydration step is performed at predetermined intervals, for example depending on the use of the probe and/or the time of immersion of the probe in molten metal.

16: An apparatus for measuring hydrogen concentration substantially as described herein, with reference to the drawings.

17. (canceled)
